(19) United States
(12) Patent Application Publication
(10) Pub. No.: US 2021/0313689 A1
(43) Pub. Date: Oct. 7, 2021

(54) ANTENNA ARRAY MADE FROM A DIELECTRIC MATERIAL

(71) Applicant: ALCAN Systems GmbH, Darmstadt (DE)

(72) Inventors: Roland REESE, Darmstadt (DE); Matthias JOST, Mainz (DE); Matthias NICKEL, Darmstadt (DE); Holger MAUNE, Darmstadt (DE); Rolf JAKOBY, Rosbach (DE); Henning TESMER, Darmstadt (DE); Ersin POLAT, Darmstadt (DE)

(73) Assignee: ALCAN Systems GmbH, Darmstadt (DE)

(21) Appl. No.: 17/267,579

(22) PCT Filed: Aug. 9, 2019
(86) PCT No.: PCT/EP2019/071441

§ 371 Date: Feb. 10, 2021

(30) Foreign Application Priority Data
Aug. 10, 2018 (DE) 10 2018 119 508.7

(51) Int. Cl. H01Q 3/36; H01Q 3/44; H01P 5/12; H01Q 13/02

(52) U.S. Cl. CPC H01Q 3/36; H01Q 13/0275; H01P 5/12; H01Q 3/44

(57) ABSTRACT

An antenna array has a signal distribution region and a signal emission region. The signal distribution region has a distribution body made from a dielectric material which converts an information signal, fed into an infeed side thereof, into a spatially distributed signal distribution on an opposite distribution side. The signal emission region has a plurality of signal emission elements distributed over the distribution side. The signal emission elements protrude from the distribution body. At least one signal emission element has a phase shift region, in which a phase shift material with an electrically influenceable permittivity is arranged in the signal emission element. By applying a phase shift voltage between at least one pair of electrodes, the permittivity of the phase shift material is influenced and thereby the propagation speed of an electromagnetic signal in the phase shift region is changed.

### TECHNICAL FIELD

The disclosure relates to an antenna array made from a dielectric material that allows a signal emission direction to be adjusted.

### BACKGROUND

Both for mobile radio and for wireless data transmission between data processing systems, high frequencies of more than 10 gigahertz up to several terrahertz offer the possibility of transmitting ever larger amounts of data per unit of time. High frequencies also offer advantages for radar systems, for example with regard to the spatial resolution made possible by high-frequency radar systems. Against this background, antennas and antenna systems suitable for the emission and reception of signals with wavelengths in the millimeter range are becoming increasingly interesting.

Due to the high free space loss of electromagnetic radiation at such high frequencies or short wavelengths, it is advantageous and often even necessary for practical applications that the antennas or antenna systems can be aligned in order to emit electromagnetic radiation particularly efficiently in a specific spatial direction or to be particularly receptive to electromagnetic waves from a predetermined spatial direction. Further requirements for such antennas or antenna systems are typically the smallest possible space requirement, the lowest possible dead weight along with the possibility to manufacture the antennas cost-efficiently and to use them as maintenance-free as possible.

It has been shown that mechanically steerable antennas that can be aligned in one spatial direction are not suitable for many applications, since mechanical control and alignment of the antenna not only requires comparatively large and heavy components, but is also limited in terms of slewing speeds and the different alignments of the antenna.

In addition, the properties of electromagnetic radiation with wavelengths in the millimeter range are problematic for practical applications. With conventional metallic waveguides, the penetration depth of electromagnetic radiation into metal decreases with the frequency of the radiation. This leads to the fact that the surface roughness of metals has a stronger effect as a disturbing influence on the wave propagation, and thus the power loss increases during the transmission of electromagnetic waves with metallic waveguides. In order to reduce this power loss, attempts are being made to manufacture antennas or antenna systems from a dielectric material in which electromagnetic radiation can propagate with significantly lower losses in the millimeter range. For example, the article entitled “A Fully Dielectric Lightweight Antenna Array Using a Multimode Interference Power Divider at W-Band”, Roland Reese et al, IEEE Antennas and Wireless Propagation Letters, vol. 16, 2017, pages 3236-3239, describes various aspects from an antenna array made entirely of a dielectric material having four signal emission elements aligned parallel to one another and extending away from a flat, essentially rectangular distribution body in a signal propagation direction. An information signal fed into the dielectric distribution body on an infeed side is converted in the distribution body into a signal distribution spatially distributed in the distribution body, such that several field maxima are formed on a distribution side opposite the infeed side due to interference, which are converted into the signal emission elements arranged in a manner corresponding to the individual field maxima. Electromagnetic waves are then emitted from each signal emission element, which superimpose on one another during propagation and propagate in a focused manner in a signal propagation direction predetermined by the signal emission elements. Thereby, the signal propagation direction is considered to be the direction in space in which an intensity maximum of the electromagnetic waves of the individual signal emission elements emitted in all directions and superimposed on one another propagates.

Such an antenna array made from a dielectric material has the advantage compared to an antenna array made from metallic components that the signal emission of high-frequency information signals with frequencies of 10 GHz and more can take place with extremely low losses during signal propagation in the dielectric material of the antenna array. The intensity maximum of the electromagnetic waves emitted by this antenna array is predetermined by the arrangement and alignment of the individual signal emission elements and typically corresponds to the alignment of the signal emission elements aligned parallel to one another.

### SUMMARY

It is an object of the present disclosure to provide an antenna array of a dielectric material such that the signal emission direction or the alignment of a maximum intensity of the signal emission can be influenced and predetermined in a simple manner.

This object is achieved with an antenna array made from a dielectric material. The antenna array has a signal distribution region and a signal emission region. The signal distribution region has a distribution body made from a dielectric material and converts an information signal, fed into the dielectric distribution body on an infeed side, into a spatially distributed signal distribution on a distribution side opposite the infeed side. The signal emission region has a plurality of signal emission elements adjoining the distribution side of the distribution body and distributed over the distribution side relative to one another. The signal emission elements protrude from the distribution body starting from the distribution side of the distribution body, and on the protruding end of which signal emission elements an emission end is formed.

At least one signal emission element has a phase shift region, in which a phase shift material with an electrically influenceable permittivity is arranged in the signal emission element. Two pairs of electrodes, arranged opposite one another, are arranged so as to surround the phase shift material. The permittivity of the phase shift material can be influenced by applying a phase shift voltage between at least one pair of electrodes. Thereby, the propagation speed of an electromagnetic signal in the phase shift region can be changed before the information signal fed into the distribution body at the infeed side is emitted by the signal emission elements.

By generating a phase shift in the individual signal emission elements and thereby differently predetermining the phase offset of two electromagnetic waves emitted in adjacent signal emission elements, the field distribution of the electromagnetic signal emitted by the antenna array, which is generated by superimposing the individual signals emitted by the individual signal emission elements, can be influenced, and thus a preferred direction of propagation can be predetermined. The phase shift in an individual signal emission element can be controlled and predetermined by applying a phase shift voltage. Expediently, the phase shift material is selected such that the response time to a change in the phase shift voltage is sufficiently small to allow a rapid change in the alignment of the signal emission. Thereby, the maximum possible phase shift within an individual signal emission element can depend, for example, on the length of the emission element, on the length of the propagation path of the electromagnetic signal in the phase shift region of the signal emission element and on the dielectric properties of the phase shift material as well as on the applied phase shift voltage. Thereby, it is readily possible to predetermine a phase shift of up to a or more in each individual signal emission element. In this manner, the signal propagation direction can be varied over an angular range of more than 45° and, where appropriate, of more than 60°, and can be achieved by applying a suitable and typically different phase shift voltage to the individual signal emission elements.

The phase shift material can be solid, liquid or gaseous. A liquid or gaseous phase shift material should be arranged in a cavity formed on or arranged on the signal emission element. A solid phase shift material can also be arranged on an outer side of the signal emission element, or can be, for example, a coating or encasement of the signal emission element formed from the dielectric material.

According to one embodiment, it is provided that a cavity extending away from the distribution side of the distribution body is formed in the phase shift region of a signal emission element, in which cavity the phase shift material is arranged. The individual signal emission elements can, for example, be manufactured from the dielectric material using a suitable injection molding process and provided with the electrodes. After filling the cavity with the phase shift material, the prepared signal emission element can be connected to the distribution body. It is also possible to manufacture such an antenna array using suitable additive or generative processes, for example using 3D printers. The cavity formed in each signal emission element can be filled through a filling opening provided during manufacture or subsequently created, which is then sealed. It is also possible to briefly interrupt the manufacturing process after the formation of the cavity that has not yet been completely closed, fill the cavity, and then continue and finish the manufacturing process.

The electrodes can be prefabricated and subsequently connected to the individual signal emission elements. The electrodes can also be vapor-deposited or printed. For the arrangement of the electrodes and their electrical contacting, processes and production facilities known from semiconductor manufacturing can be used.

With a view to influencing the phase shift in the phase shift region of a signal emission element as simply and reliably as possible, it can be advantageous for the signal emission element to have a rectangular cross-sectional area in the phase shift region, such that the electrodes arranged opposite one another in pairs are arranged on flat side wall surfaces of the signal emission element in the phase shift region. The signal emission element can also have a circular or oval cross-sectional area, and the electrodes arranged in pairs opposite one another can cover curved regions of respective side wall surfaces of the signal emission element. It is also possible that the electrodes are arranged at a distance from the signal emission element in such a manner that an advantageous field distribution of an electric field predetermined by the phase shift voltages can be formed in the phase shift region in order to be able to influence the phase shift material in the phase shift region in a suitable manner.

In order to reduce any losses in signal emission from the signal emission element and to assist in the desired directional signal emission, it is optionally provided that each emission element has a tapered emission end. For example, the tapered emission end can be formed to be essentially flat and have a triangular base area with a pointed emission end. The tapered emission end can also be in the shape of a pyramid, obelisk or cone. The dimensions of the tapered emission end of the signal emission element are suitably matched to the wavelength of the information signal that is to be emitted by the antenna array.

It can be expedient that each signal emission element is able to be separately manufactured and is connected to the distribution body via a connection interface. Thereby, the individual signal emission elements can be arranged not only along a line on the distribution side of the distribution body, but can also be arranged in matrix form in a manner distributed over an area of the distribution side of the distribution body, forming a three-dimensional arrangement of the individual signal emission elements. By separately manufacturing individual signal emission elements, the manufacturing effort for individual signal emission elements and in particular the manufacturing effort for an antenna array with a number of signal emission elements can be reduced. The connection interface can be a region formed to be flat on the distribution side of the distribution body. The connection interface can also be a recess in the distribution side of the distribution body, into which a connection end of the signal emission element adapted thereto can be inserted and clamped or adhesively secured therein.

In accordance with an advantageous embodiment, the distribution body has a cuboid distribution region. A cuboid distribution region favors the formation of discrete maxima at a distance from the infeed side of the information signal that is fed. In addition, a cuboid distribution region can be manufactured in a simple manner. The distribution body can optionally have an infeed region tapering towards the infeed side. An infeed region that tapers towards the infeed side reduces and mitigates discontinuities and sudden widening in signal routing, which could lead to undesired emission losses in the infeed region.

In accordance with a particularly advantageous embodiment, it is provided that a signal infeed element can be arranged on the infeed side of the distribution body selectively at different infeed positions arranged in a distributed manner over the infeed side and can be connected to the infeed side of the distribution body in such a manner that the information signal can be fed from the signal infeed element into the distribution body. The different infeed positions distributed over the infeed side mean that different signal path lengths can be predetermined for the information signal from the respective infeed position to the individual signal emission elements. Due to the different signal path lengths in the distribution body, a phase difference of the electromagnetic waves transferred to the individual signal emission elements is already predetermined. In this manner, by specifying different infeed positions on the infeed side of the distribution body, the emission direction of the information signal is already influenced and predetermined by the individual signal emission elements.

Setting different infeed positions for the information signal fed into the distribution body can be used to predetermine the direction of a maximum intensity of the signal emission of an antenna array made from a dielectric material, independently of a phase shift caused in the individual signal emission elements. This makes it possible to influence and predetermine a signal emission direction even for antenna arrays whose signal emission elements do not have a separate phase shift region.

By combining the two options, an antenna array can achieve a particularly precise specification and change in the emission characteristic over a large solid angle range. Due to a phase shift caused by a changed infeed position, the dimensions of the phase shift region can be reduced, and a smaller space requirement of the antenna array can be made possible with a constant angle change. It is also possible, for example, for a plurality of different infeed positions to be predetermined on the infeed side of the distribution body, which can be used selectively for signal infeed and can change the direction of signal emission in discrete steps of, for example, 10° or 5°. By applying an individual phase shift voltage to the individual signal emission elements, an additional influence on the signal emission direction can then be effected and the signal emission direction can be changed and predetermined in degree steps or even in fractions of a degree. By combining both options for phase shift, a larger overall angular range can be covered for the alignment of the signal propagation direction.

For such a control of the emission direction of the antenna array, it is advantageous that the distribution body has a plurality of infeed contact interfaces on the infeed side, in which a signal infeed element can be brought into contact with the distribution body transmitting the information signal. Each infeed contact interface can be connected to a signal infeed element, wherein the information signal is fed via only one of the signal infeed elements at a time. The contacting of a selected signal infeed element to the distribution body can be accomplished by electronic circuitry, such that no mechanical components are required. It is also possible to mechanically relocate an individual signal infeed element and connect it to the desired infeed contact interface as required.

In principle, it is also conceivable that a signal infeed element is not only connected to the infeed side of the distribution body at infeed contact interfaces arranged at a distance from one another, but is continuously displaced across the infeed side of the distribution body and is connected or can be connected to the distribution body at any infeed position.

According to a particularly advantageous embodiment, it is provided that the phase shift material is an electrically influenceable liquid crystal material. Liquid crystal materials can have significantly different permittivities even at low electrical voltages of a few volts, such that significant phase shifts can be caused by electrical voltages that can be generated without major design or circuitry effort. Liquid crystal materials are easy to process and can be reliably influenced under the typically prevailing environmental conditions over a long period of use, in order to precisely predetermine different phase differences.

### BRIEF DESCRIPTION OF THE DRAWINGS

FIG. 1 shows a schematic sectional view of an antenna array made from a dielectric material with a signal distribution region and with a signal emission region in which four signal emission elements are arranged, each with a phase shift region.

FIG. 2 is a sectional view along line II-II in FIG. 1 through a signal emission element of the antenna array shown in FIG. 1,

FIG. 3 is a sectional view in accordance with FIG. 2 through a differently designed signal emission element.

FIG. 4 is a schematic sectional view of the antenna array shown in FIG. 1 with indicated signal transmission paths for an information signal fed centrally at an infeed side to the individual signal emission elements.

FIG. 5 is a schematic sectional view in accordance with FIG. 4 with indicated signal transmission paths for an information signal fed in at an upper edge of an infeed side to the individual signal emission elements.

FIG. 6 is a view of an end face of the antenna array shown in FIG. 1 with a matrix of 4×4 signal emission elements arranged at a distance from one another.

FIG. 7 is a schematic sectional view through an individual signal emission element.

FIG. 8 is a schematic sectional view through a signal emission element with a different design.

FIG. 9 is a schematic sectional view through a signal emission element in turn with a different design.

### DETAILED DESCRIPTION

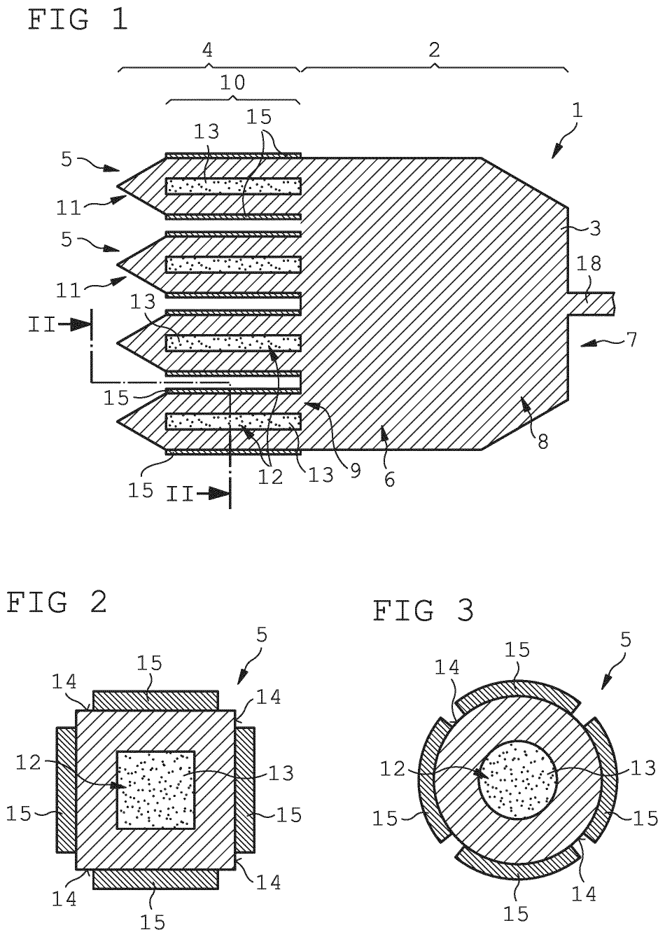

An exemplary antenna array 1 as shown schematically in a sectional view in FIG. 1 has a signal distribution region 2 with a distribution body 3 made from a dielectric material and a signal emission region 4 with a plurality of signal emission elements 5.

The distribution body 3 has a cuboid distribution region 6 and an infeed region 8 tapering towards an infeed side 7. At the infeed side 7, an information signal can be fed into the distribution body 3 via an infeed element 18. The distribution body 3 is manufactured in one piece from a suitable dielectric material, for example Rexolite® 1422 made by C-Lec Plastics Inc. However, the distribution body 3 could also be assembled from several separately fabricated components, for example for the cuboid distribution region 6 and for the tapering infeed region 8, or assembled or connected in a suitable manner.

The signal emission elements 5 arranged in the signal emission region 4 are arranged on a distribution side 9 of the distribution body 3, in such a manner that the respective adjacent signal emission elements 5 are regularly spaced apart relative to one another. The signal emission elements 5 are also formed of a dielectric material. This can be the same dielectric material as the signal distribution region 2. In such a case, the signal distribution region 2 and the signal emission region 4 or the distribution body 3 and the individual signal emission elements 5 can be formed in one piece. However, the signal distribution elements 5 can also be manufactured separately and can be made from another suitable dielectric material.

In each signal emission element 5, a phase shift region 10 and an emission end 11 are formed. In the phase shift region 10, the signal emission element 5 has a cavity 12 that is filled with a suitable phase shift material 13, which can have a variable permittivity as a function of an electric field in the cavity 12. For example, a phase shift material 13 suitable for many applications is an electrically influenceable liquid crystal material whose permittivity can assume significantly different values as a function of an electric field.

Electrodes 15 made from an electrically conductive material are respectively arranged on opposite outer surfaces 14 of the signal emission element 5. The electrodes 15 can be deposited metal layers or metal elements, which are electrically conductively connected in pairs to a phase shift voltage device (not shown), such that a phase shift voltage can be applied between opposing electrodes 15. The electrodes 15 could also be arranged at a possibly small distance from the outer surfaces 14 of the signal emission element 5, in order to avoid undesired interference with the electromagnetic waves propagating in the signal emission element.

FIG. 2 shows an example of the arrangement of two pairs of electrodes 15 formed to be flat in the circumferential direction around a signal emission element 5 with a square cross-sectional area. Thereby, the individual electrodes 15 are connected over their entire surface to an associated outer surface 14. FIG. 3 shows a comparable arrangement of electrodes 15 around a signal emission element 5, wherein the signal emission element 5 has a circular cross-sectional area and the individual electrodes 15 are each formed as a circular segment in the circumferential direction and are arranged at a distance from one another in pairs opposite one another.

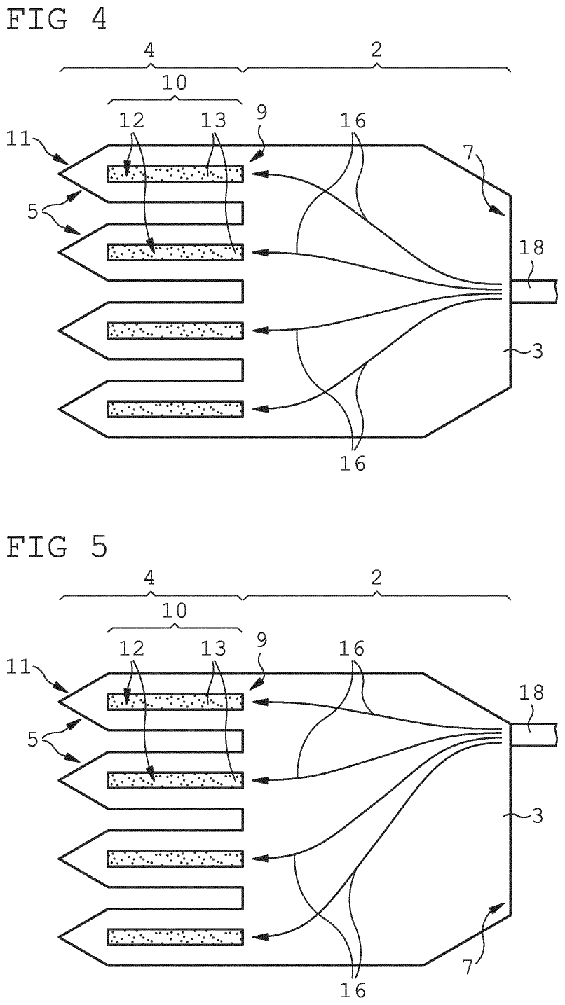

FIG. 4 shows a schematic representation of the antenna array 1 already shown in FIG. 1. An information signal fed to the infeed side 7 and the respective signal paths 16 of the electromagnetic waves of the information signal propagating in the distribution body 3 are illustrated. As a result of superimpositions of the individual wave fronts, discrete intensity maxima, which are coupled into the signal emission elements 5 adjacent to the distribution body 3 at the distribution side 9, or whose electromagnetic waves propagate into the signal emission elements 5, are created at the distribution side 9 of the distribution body 3. The individual signal paths 16 have a slightly different signal path length from the infeed side 7 to the distribution side 9 of the distribution region 2. This results in a comparatively small phase shift of the wave fronts of the electromagnetic waves propagating in the adjacent signal emission elements 5. Such signal path lengths or the resulting phase shifts are predetermined by the shape of the distribution body 3 and the infeed of the information signal. By arranging the signal emission elements 5 as symmetrically as possible and a center arrangement of the infeed position of the information signal on the infeed side 7, the effects of phase shifts on the path to the individual signal emission elements 5 can be minimized. In order to support the most focused and directed superimposition possible of the electromagnetic waves emitted by the signal emission elements 5, the slight phase shifts caused by the different signal path lengths can be compensated for by different dimensions of the signal emission elements 5 adapted thereto.

By applying a phase shift voltage to the electrodes 15 on a signal emission element 5, the permittivity of the relevant phase shift material 13 in the cavity 12 of the signal emission element 5, and thus the dielectric properties of the phase shift region 10, can be influenced and altered such that a desired phase shift in the electromagnetic waves propagating along the phase shift region 10 of the signal emission element 5 up to the emission end 11 is generated. For each signal emission element 5, an individually predetermined phase shift can be generated when the respective electrodes 15 are suitably controlled. The electromagnetic signals emitted by the individual signal emission elements 5 are superimposed and form an emission maximum of the greatest signal intensity in a signal propagation direction. The signal propagation direction can be precisely predetermined through a suitable specification of the individual phase shifts. With phase shifts of up to a in the individual signal emission elements 5, the signal propagation direction can be changed and predetermined within an angular range of ±45° or even of up to ±60° and more.

In this manner, by applying suitable phase shift voltages to the individual signal emission elements 5, the signal propagation direction can be predetermined, wherein a controlled or regulated alignment or tracking of the signal propagation direction is possible. No mechanical components or actuators are required to change the signal propagation direction.

In FIG. 5 shows the antenna array 1 as in FIG. 4 with an infeed of the information signal on the infeed side 7 that differs from FIG. 4. The information signal is fed by the infeed element 18 not centrally, but at an edge region of the distribution body 3. FIG. 5 also shows schematic signal paths 16 for the electromagnetic waves of the information signal propagating in the distribution body 3. The signal path lengths of the individual signal paths 16 differ significantly from the signal path lengths of the central infeed of the information signal shown in FIG. 4. This results in a significantly different phase shift of the individual electromagnetic waves that couple into and propagate through the signal emission elements 5.

The phase shifts in the individual signal emission elements 5 caused by the spatially different infeed of the information signal via the infeed side 7 can also be used to change the signal emission direction. With a suitable embodiment of the antenna array 1, different signal propagation directions of the electromagnetic signals emitted from the signal emission elements 5 can be set solely by different infeed positions of the information signal at the infeed side 7 of the distribution body 3. It is considered particularly advantageous if different infeed positions for the information signal are combined with different phase shifts in the phase shift regions 10 of the individual signal emission elements 5.

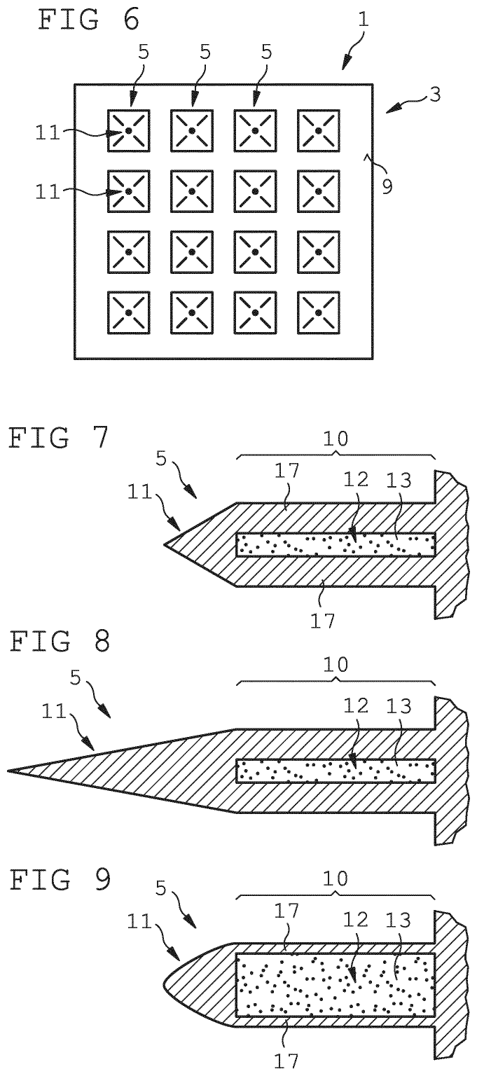

FIG. 6 shows a schematic view of one end face of the antenna array 1 shown in FIGS. 1, 4 and 5. The signal emission elements 5 projecting from the distribution side 9 of the distribution body 3 are arranged in matrix form in a regular arrangement of 4×4 signal emission elements 5 in a manner distributed over the distribution side 9. Other base areas of the distribution side 9 of the distribution body 3, for example circular, oval or polygonal base areas, are also conceivable. The individual signal emission elements 5 can also be arranged irregularly in a manner distributed over the distribution side 9.

FIGS. 7 to 9 show exemplary different embodiments or shapes of different signal emission elements 5, each in a sectional view. The signal emission element 5 shown in FIG. 7 has a comparatively long phase shift region 10 and, in contrast, a significantly shorter emission end 11. The cavity 12 in the phase shift region 10 is surrounded by comparatively thick sidewalls 17.

In the embodiment shown in FIG. 8, the phase shift region 10 is significantly shorter than in the embodiment shown in FIG. 7. On the other hand, the emission end 11 is significantly longer and even longer than the phase shift region 10.

With the embodiment shown in FIG. 9, the cavity 12 is surrounded by side walls 17 that are designed to be essentially thinner than in the embodiments shown above. The emission end 11 has a tapered region with curved contours.

1.-9. (canceled)

10. An antenna array (1), comprising:
a signal distribution region (2) and a signal emission region (4), the signal distribution region (2) having
a distribution body (3) made from a dielectric material that converts an information signal, fed into the distribution body (3) on an infeed side (7), into a spatially distributed signal distribution on a distribution side (9) opposite the infeed side (7),
wherein the signal emission region (4) has a plurality of signal emission elements (5) adjoining the distribution side (9) of the distribution body (3) and distributed over the distribution side (9) relative to one another,
wherein the signal emission elements (5) protrude from the distribution body (3) starting from the distribution side (9) of the distribution body (3) and include emission ends (11) formed on protruding ends thereof,
wherein at least one signal emission element (5) has a phase shift region (10) in which a phase shift material (13) with an electrically influenceable permittivity is arranged in the signal emission element (5),
wherein two pairs of electrodes (15), each arranged opposite one another, are arranged so as to surround the phase shift material (13),
wherein the electrically influenceable permittivity of the phase shift material (13) is influenced by applying a phase shift voltage between at least one pair of the electrodes (15) and thereby a propagation speed of an electromagnetic signal in the phase shift region (10) is changed before the information signal fed into the distribution body (3) at the infeed side (7) is emitted by the signal emission elements (5).

11. The antenna array (1) according to claim 10,
wherein a cavity (12) extending away from the distribution side (9) of the distribution body (3) is formed in the phase shift region (10) of the at least one signal emission element (5), in which cavity the phase shift material (13) is arranged.

12. The antenna array according to claim 10,
wherein the at least one signal emission element (5) has a rectangular cross-sectional area in the phase shift region (10), such that the electrodes (15) arranged in pairs opposite one another are arranged on flat side wall surfaces (14) of the at least one signal emission element (5) in the phase shift region (10).

13. The antenna array (1) according to claim 10,
wherein each signal emission element (5) has a tapered emission end (11).

14. The antenna array (1) according to claim 10,
wherein each signal emission element (5) is a separately manufactured component and is connected to the distribution body (3) via a connection interface.

15. The antenna array (1) according to claim 10,
wherein the distribution body (3) has a cuboid distribution region (6).

16. The antenna array (1) according to claim 10,
wherein a signal infeed element (18) is arranged on the infeed side (7) of the distribution body selectively at different infeed positions arranged in a distributed manner over the infeed side (7) and connected to the infeed side (7) of the distribution body (3) in such a manner that the information signal is fed from the signal infeed element (18) into the distribution body (3).

17. The antenna array (1) according to claim 16,
wherein the distribution body (3) has a plurality of infeed contact interfaces on the infeed side (7), in which a signal infeed element (18) can be brought into contact with the distribution body (3) transmitting the information signal.

18. The antenna array (1) according to claim 10,
wherein the phase shift material (13) is an electrically influenceable liquid crystal material.
